(19) United States
(12) Patent Application Publication
(10) Pub. No.: US 2003/0115919 A1
(43) Pub. Date: Jun. 26, 2003

(54) Combination lock dial and bottom tumbler for a permutation or combination lock

(76) Inventors: Christopher R. Haczynski, Monee, IL (US); Larry L. Carpenter, Chicago Heights, IL (US)

Correspondence Address: Todd S. Parkhurst, Holland & Knight LLP, Suite 800, 55 West Monroe Street, Chicago, IL, 60603-5144, US

(21) Appl. No.: 10/034,000

(22) Filed: Dec. 20, 2001

(51) Int. Cl. E05B 1/00; E05B 3/00

(52) U.S. Cl. 70/445

(57) ABSTRACT

For use in a permutation lock, a combination of a bottom number and nose element and knob and dial element are provided. The knob portion of the knob and dial element defines an axially extending female recess having a plurality of formations (for example, eight flats arrayed in an octagon, or forty teeth) such as flats which are symmetrically disposed around the circumferential surface on the recess. In like manner, the nose portion of the bottom tumbler and nose element is provided with an axially extending male nose having a like number of similarly shaped surface elements adapted to fit within and snugly engage the knob and dial recess in any one of a finite plurality of angularly spaced apart positions.

### BACKGROUND OF THE INVENTION

Today, relatively low security combination or permutation padlocks are widely used in locker rooms, storerooms and elsewhere. Under current assembly-practice for these locks, the lock dial and knob element is first affixed to the immediately adjacent lock tumbler, commonly termed the bottom tumbler. The rest of the lock parts are then assembled to provide the completed lock.

In use, these combination padlocks commonly require that the user turn the dial to set a series of three numbers immediately adjacent an index marking. In so doing, the lock user rotates the bottom tumbler and two adjacent tumblers so as to axially align pins, recesses or other formations on the lock tumblers and consequently permit the lock shackle to be freed, thus opening the lock.

Under current practice, fixed relationships are established between the three lock tumblers and the lock dial. Thus, for every combination lock offered for sale, a lock with that combination must be individually manufactured and stocked. If the manufacturer chose to offer 5000 distinct combinations, for example, manufacturing and stocking requirements would dictate that 5000 inventory storage bins or locations be created to individually store all those combination padlocks.

It is accordingly a general object of this invention to provide revised designs for the knob and dial element and for the bottom tumbler element and to provide a new method of assembly so that relatively few partially assembled locks can be inventoried. When required, the lock assembly can be quickly and easily completed. The assembly can have any one of a large number of lock opening combinations.

It is a more specific object of the invention to provide a knob and dial element and a bottom tumbler element with a regular polygonal shape (for example, an octagonal array) of mating surfaces. By positioning the dial in any one of the eight positions of the octagon, spaced apart by 45 degrees, it is possible to obtain eight distinct combinations that are translated by increments of five dial numerals.

It is an associated specific object of the invention to reduce the manufacturing and stocking requirements for bottom tumblers from 40 to 5, thereby reducing inventory, tooling requirements, and consequent manufacturing costs.

A related object of the invention is to provide redesigned knob and dial elements and bottom tumbler elements which will permit the knob and dial element to be the last component assembled to the padlock, thus allowing non-dedicated sub-assemblies to be stored without dials. The sub-assemblies will be kept in inventory awaiting customer orders. When locks are ordered, dials will be specifically assembled on the padlocks based on customer orders and requirements.

Another specific object on the invention is to provide the bottom tumbler elements and dial elements in forms which are designed to accept a commercially available blind rivet of the “POP” blind fastener variety. This permits the dial to be attached to the lock assembly even though access to the assembly is available from one side only. The normal assembly action of the blind rivet pulls the bottom tumbler and dial together to create a positive seating action between these elements in a rapid and economical manner.

Other objects and advantages of the invention will become apparent upon reading the following detailed description and upon reference to the drawings. Throughout the drawings, like reference numerals refer to like parts.

### DESCRIPTION OF THE DRAWINGS

FIG. 1 is an elevational view of an assembled combination padlock embodying the present invention.

FIG. 2 is a sectional view of the padlock shown in FIG. 1 taken substantially in the plane of line 2-2.

FIG. 3 is an exploded view of the combination padlock, showing the knob and dial element and the bottom tumbler and nose element in exploded relationship to the padlock body.

FIG. 4 is a front elevational view of the knob and dial element.

FIG. 5 is a sectional view of the knob and dial element taken substantially in the plane of line 5-5 in FIG. 4.

FIG. 6 is a rear view of the knob and dial element shown in FIGS. 4 and 5.

FIG. 7 is a front elevational view of the tumbler and nose element.

FIG. 8 is a rear view of the tumbler and nose element shown in FIG. 7.

FIG. 9 is a side elevational view of the tumbler and nose element shown in FIGS. 7 and 8.

FIG. 10 is a sectional view of the tumbler and nose element taken substantially in the plane of line 10-10 in FIG. 8.

FIG. 11 is a front elevational view of a tumbler and nose element having an alternate design and shape.

FIG. 12 is a side elevational view of the tumbler and nose element shown in FIG. 11.

FIG. 13 is a front elevational view of a tumbler and nose element having another alternate design and shape.

FIG. 14 is a side elevational view of the tumbler and nose element shown in FIG. 13.

FIG. 15 is a front elevational view of a tumbler and nose element having yet another alternate design and shape.

FIG. 16 is a side elevational view of the tumbler and nose element shown in FIG. 15.

While the invention will be described in connection with a preferred embodiment and procedure, it will be understood that it is not intended to limit the invention to this embodiment or procedure. On the contrary, it is intended to cover all alternatives, modifications and equivalents as may be included within the spirit and scope of the invention as defined by the appended claims.

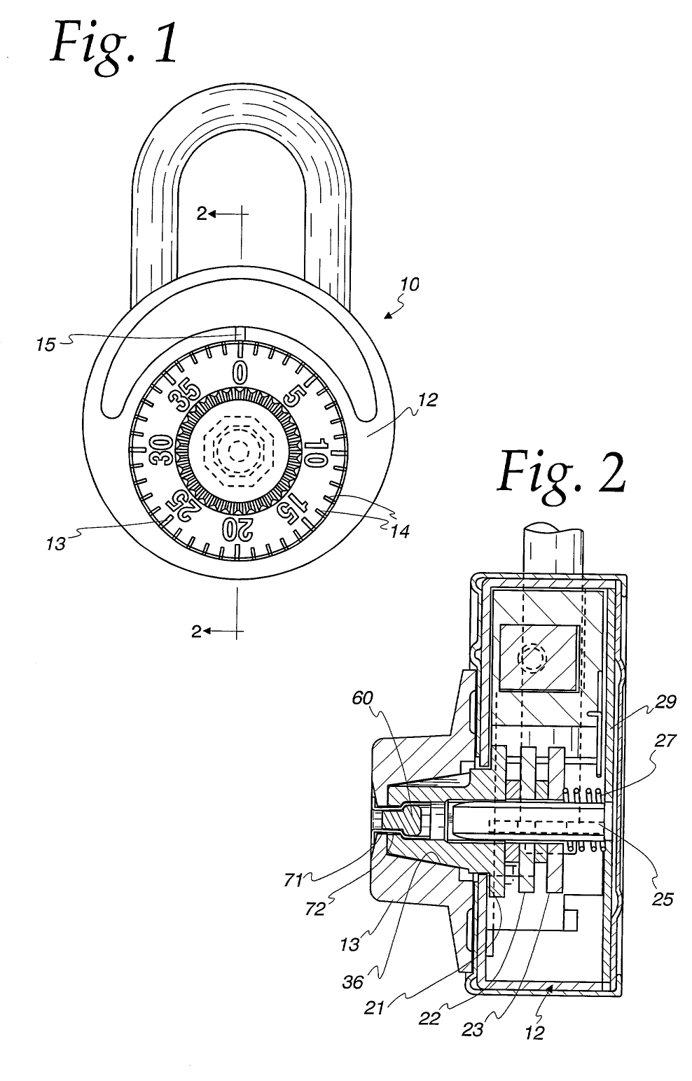

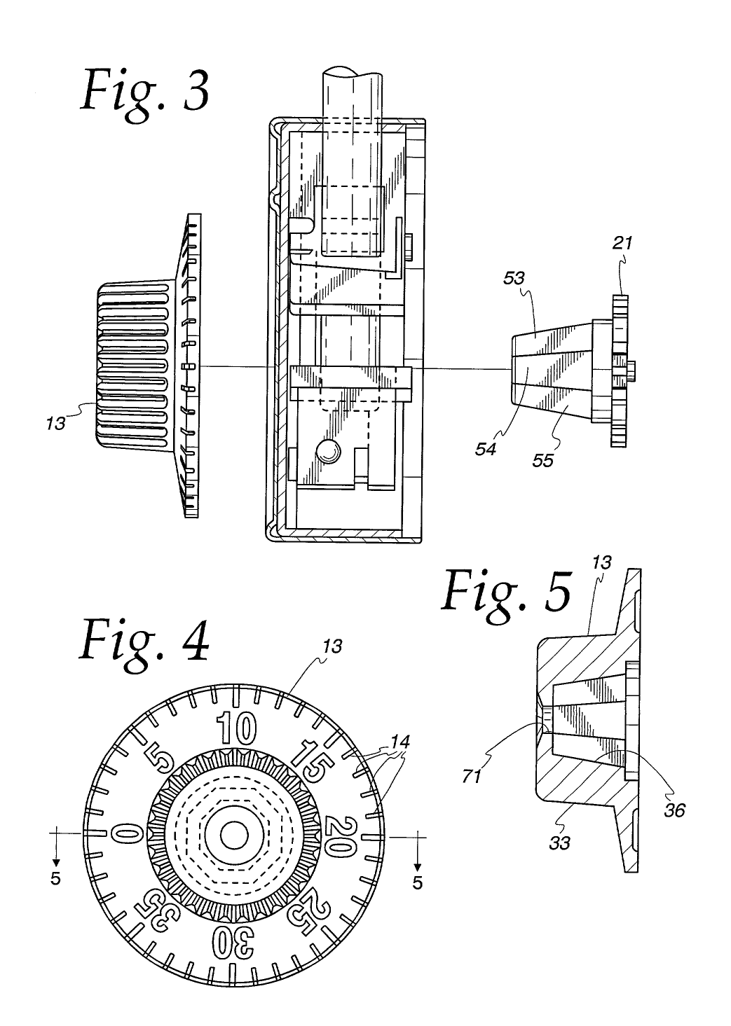

Turning first to FIG. 1, there is shown a padlock 10 which includes an embodiment of the present invention. This padlock 10 includes a lock body 12 upon which is mounted a knob and dial element 13. Around the dial periphery are provided evenly spaced, numbered indicia 14. By twisting or turning the knob and dial 13, these indicia 14 may be aligned adjacent a body indicia marker 15, in well-known manner.

As shown in FIG. 2, within the lock body 12 are a number (here, three) of lock tumblers 21, 22 and 23 mounted on a common shaft 25. A coil spring 27 extends between a lock body back 29 and the tumbler 23 so as to urge the tumblers 23 into mutually engaging positions. The interengagement and cooperation of these tumblers 21-23 with one another and with other lock parts (not shown here) are disclosed in co-owned U.S. Pat. Nos. 4,055,972 and 4,170,884, and consequently will not be further described here.

In these prior art locks, the traditional method of assembly called for the knob and dial element 13 to be assembled, and to be affixed to the adjacent bottom tumbler element 21 in an early, if not the first, step in the assembly of the lock. Unique knob and dial element and adjacent bottom tumbler element assemblies were required for every lock; that is, forty different permutations of these assemblies were required since the dial traditionally carries forty numbers or hackmarks. Accordingly, forty different bottom tumblers were required to be manufactured and kept in inventory.

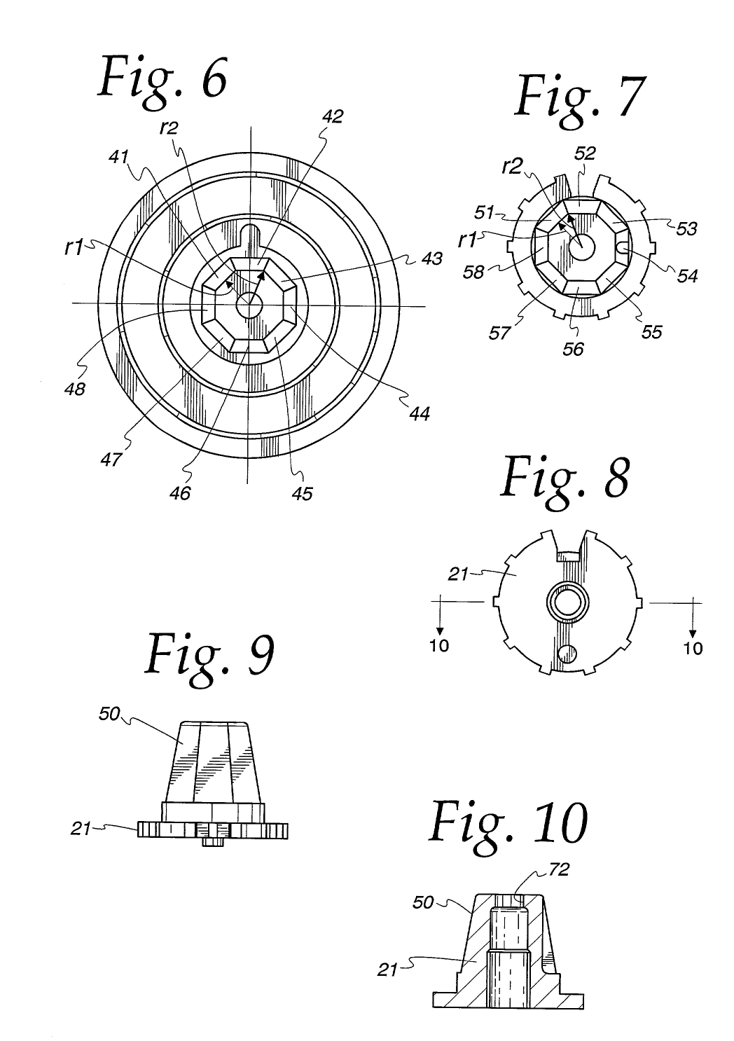

To reduce the number of bottom tumblers required to assemble these locks in accordance with the invention, the knob portion 33 of the knob and dial element 13 defines an axially extending female recess 36 which has a plurality of radially varying formations symmetrically disposed around the circumferential surface of the recess 36, as suggested in FIGS. 2 and 5. In an embodiment shown in FIGS. 5 and 6, these formations comprise eight flats 41-48 are disposed in a regular polygonal (here, an octagonal) array or shape as shown in FIG. 6. Similarly, the nose portion 50 of the bottom tumbler and nose element 21 is an axially extending male member having a plurality of radially varying formations symmetrically disposed around the circumference of the nose member 50, as suggested in FIGS. 7, 8 and 9. In the preferred embodiment shown in the drawings, these formations comprise eight flats 51-58 disposed in a regular polygonal (here, octagonal) array or shape.

As illustrated in FIG. 2, the knob and dial element 13 can be drawn into engagement with and permanently attached to the bottom tumbler and nose element 21. To avoid having to access the assembly from both sides in accordance with another aspect of the invention, the parts 13 and 21 are here secured together by a blind or so-called POP rivet 60 which is drawn through axially mating holes 71 and 72. To provide a snug, secure and permanent fit, the female recess 36 and the male nose 50 have coincident generally conical shapes.

It will be apparent that the formations 41-48 and 51-58 may be of any like shape and like varying radius, as suggested by comparison of radius r1 and radius r2 in FIGS. 6 and 7. These formations could be, for example, lands and grooves of square, rectangular or semicircular cross-sectional shape.

Moreover, any number of these shapes can be provided on the nose 50 and in the recess 36. If more of the shapes are provided, more bottom tumbler numbers can be utilized. Here, as shown in FIGS. 6-9, eight flats are provided in an octagonal array. This octagonal array provides permits a total of five differently arrayed or formed tumblers to use or access all forty of the indicia hackmarks or numbers appearing on the knob dial, as shown in the following table:

| | |
|---|---|
| | “FLAT” SURFACE SHOWN IN FIG. 7 USED |
| Bottom | TO CREATE SPECIFIC BOTTOM TUMBLER |
| Tumbler | NUMBER WITH DIAL/KNOB |

| Number | 54 | 55 | 56 | 57 | 58 | 51 | 52 | 53 |
|---|---|---|---|---|---|---|---|---|
| 1 | 36 | 31 | 26 | 21 | 16 | 11 | 6 | 1 |
| 2 | 35 | 30 | 25 | 20 | 15 | 10 | 5 | 40 |
| 3 | 34 | 29 | 24 | 19 | 14 | 9 | 4 | 39 |
| 4 | 33 | 28 | 23 | 18 | 13 | 8 | 3 | 38 |
| 5 | 32 | 27 | 22 | 17 | 12 | 7 | 2 | 37 |

As the drawings suggest, a predetermined number of indicia (here, forty) is equal to or less than the finite number of angularly spaced apart positions of the elements (here, eight). Thus, by providing only five different bottom tumblers, each tumbler having eight flats, all forty of the dial indicia can be utilized. Thus, in accordance with the invention, the number of dial and knob elements and the number of bottom tumbler elements which must be manufactured and kept in inventory is greatly reduced.

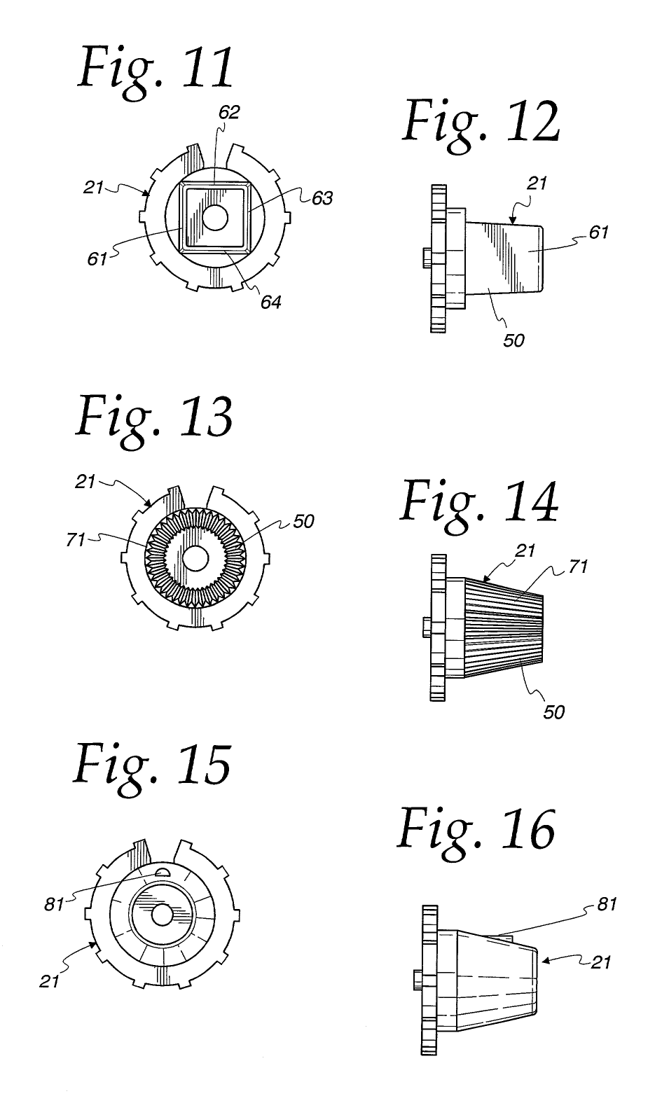

An alternate bottom tumbler design is shown in FIGS. 11 and 12. Here four flats 61-64 are provided, and thus ten tumblers would be required to utilize the full array of 40 of the indicia hackmarks, in accordance with

$$t = \frac{h}{f}$$

where:

t is the number of tumblers required to be manufactured to use all the indicia hackmarks;

h is the number of hackmarks; and

f is the number of flats provided on the tumbler.

Another tumbler design is shown in FIGS. 13 and 14. Here, forty radially varying teeth 71 are provided on the nose 50 of the tumbler 71; and a mating forty teeth are provided on the recess of the knob and dial element 13. If this embodiment is employed, only one tumbler 21 need be manufactured.

Yet another tumbler design is shown in FIGS. 15 and 16. A pin 81 could be provided on the tumbler 71, and pin recesses could be provided at a number of places—e.g., four or eight or ten—on the knob and dial element 13. Again, in accordance with the invention, the number of knob and dial elements 13 and the number of bottom tumbler elements which must be manufactured and kept in inventory is greatly reduced.

1. For use in a permutation lock, the combination of a bottom tumbler and nose element and a knob and dial element:
the knob portion of the knob and dial element defining an axially extending female recess, the recess having a plurality of radially varying formations symmetrically disposed around the circumferential surface of the recess; and
the nose portion of the bottom tumbler and nose element comprising an axially extending male nose, the nose having a plurality of radially varying formations symmetrically disposed around the circumferential surface on the nose, the nose being adapted to fit within and engage the knob and dial recess in any one of a finite plurality of angularly spaced apart positions.

2. For use in a permutation lock, the combination of a bottom tumbler and nose element and a knob and dial element:
the knob portion of the knob and dial element comprising an axially extending female recess, the recess having a plurality of flats disposed symmetrically around the circumferential surface of the recess; and
the nose portion of the bottom tumbler and nose element comprising an axially extending male nose, the nose having an equal plurality of flats disposed symmetrically around the circumferential surface of the nose and being adapted to fit within and engage the knob and dial recess in any one of an equal plurality of angularly spaced apart positions.

3. The combination according to claim 2 wherein eight flats are formed on the knob recess and a corresponding eight flats are formed on the nose of the bottom tumbler and nose element.

4. The combination according to claim 1 wherein the identically shaped radially varying formations formed on the circumferential surface of the knob recess and formed on the circumferential surface on the nose of the bottom tumbler and nose element are identically shaped.

5. The combination according to claim 1 wherein said knob and dial element is integrally formed.

6. The combination according to claim 1 wherein said bottom tumbler and nose element is integrally formed.

7. The combination according to claim 1 further including means for permanently affixing the knob recess to the tumbler nose in any one of said finite plurality of angularly spaced positions.

8. The combination according to claim 7 wherein said means for permanently affixing the knob recess to the tumbler nose comprises a blind pop rivet.

9. For use in a permutation lock, the combination of a bottom tumbler and nose element and a knob and dial element:
one element having an axially extending female recess and the other element having an axially extending male nose adapted to fit within the female recess; and
a plurality of angularly spaced apart, radially varying mutually interengaging surfaces being formed on the nose surface and the recess surface to key the knob and dial element together with the bottom tumbler and nose element in any one of a finite plurality of relative, angularly spaced apart positions.

10. A combination according to claim 9 wherein said dial is marked with a predetermined number of indicia, and wherein said predetermined number of indicia is equal to or greater than said finite number of angularly spaced apart positions of said elements.
